(19) United States
(12) Patent Application Publication
(10) Pub. No.: US 2022/0142297 A1
(43) Pub. Date: May 12, 2022

(54) SHOE MIDSOLE WITH VARIABLE DIMENSION HELICAL SPRING MADE BY ADDITIVE MANUFACTURING PROCESS

(71) Applicant: National Taiwan University of Science and Technology, Taipei (TW)

(72) Inventors: Aamer Nazir, Taipei (TW); Jeng-Ywan Jeng, Taipei (TW); Mubasher Ali, Taipei (TW)

(21) Appl. No.: 17/093,573

(22) Filed: Nov. 9, 2020

(51) Int. Cl. A43B 13/18

(52) U.S. Cl. CPC A43B 13/182

(57) ABSTRACT

A shoe midsole having a structure formed by additive manufacturing process, including a bottom pad, an upper pad and a shock-absorbing layer. The bottom pad has foot-shaped profile and includes a plurality of stress zones. The upper pad is arranged opposite to the bottom pad and has foot-shaped profile almost identical to that of the bottom pad. The shock-absorbing layer is arranged between the bottom pad and the upper pad and includes a plurality of pressure-bearing units. The pressure-bearing unit is arranged between the bottom pad and the upper pad in the manner that two ends of each pressure-bearing unit abut against the bottom pad and the upper pad respectively. The pressure-bearing unit has excellent mechanical properties such as higher energy absorption and force bearing capacity for bearing pressures or stress put by the foot, good flexibility and higher deflection capacity that can be elastically deformed in the longitudinal direction.

### BACKGROUND OF THE INVENTION

### Technical Field

The invention relates to a shoe midsole, particularly to a shoe midsole comprising various helical spring-like units, made by additive manufacturing process.

### Background

Sports shoes are generally composed of a sole and an upper cover. The sole can be divided into three elements from the inside to the outside, which mainly include insole, midsole and outsole.

Generally, the insole is made of a very soft material to provide the feet with comfort, and further to provide cushioning and stability for the user during the running and walking, thereby protecting the user's ankles, knees and waist from serious injuries.

The midsole is characterized by stability, impact energy absorption, and energy release. The traditional midsole is made from ethylene vinyl acetate (EVA) as a raw material by using a compression injection molding process.

The outsole should be a substrate with certain degree of stiffness, wear resistance, and be able to bear force caused by interacting with the ground during a person is walking or running.

In the past, shoe soles were designed and manufactured by various technologies, most of them were made by compression injection molding process. However, the compression injection molding process is difficult to be adjusted to manufacture the soles with various size for different users, and is not easy to make shoes in small batches of customized production. Such manufacturing technologies cannot be targeted immediately to produce soles suitable for various factors such as foot size and walking form of different users. Therefore, new manufacturing technology related to the design and production of soles, for example, 3D printing technology has been developed and utilized. Among them, with high accuracy and variability, an additive manufacturing process is quite suitable for manufacturing footwear products and application in customized production.

In order to increase absorption efficiency of shock of the shoes, a plurality of spring-like cushioning and vibration damping elements were suggested to provide in structure of a shoe midsole, according to the disclosures of several patents such as U.S. Pat. No. 7,600,330, Taiwan patent No. 1666995 and Taiwan patent No. M311288.

In FIG. 1 showing force distribution of the pressures put on foot of a person when he is walking and running, it shows different portions of the sole exert different forces on the midsole while walking or running, and the darker in color shows the greater pressure. As shown in FIG. 1, the distributed areas between the soles of the feet and the heels mainly shows by darker colors, while the other areas are shown with lighter color. Accordingly, it is required to have a shoe midsole structure capable of bearing greater pressure on forefoot and the heels.

Since the existing shoe midsole are formed with spring-like cushioning and damping elements in same size and mechanical properties, it cannot achieve an appropriate damping effect that is in compliance with various forces on different areas of the sole, and thus it is easy to cause discomfort or even injury to the foot.

Consequently, it is in need of a shoe midsole that has a structure capable of improving various problems and shortcomings of prior art as above-mentioned, and also has excellent mechanical stability and comfort.

### SUMMARY OF THE INVENTION

Therefore, in view of the deficiencies in the prior study, the inventor through careful research, numbers experimentation and perseverance spirit, finally accomplished the present invention to solve the shortcomings of the prior studies.

Namely, the object of the present invention is to provide a shoe midsole that is made by additive manufacturing process and comprises a plurality of pressure-bearing units made of variable-dimension helical springs. Each pressure-bearing unit has mechanical property for bearing forces put on the stress zones by the foot and is arranged in accordance with different forces to provide an even shock-reducing effect, comfort on the users and to avoid causing sports injury.

According to one illustrated example of the invention, a shoe midsole comprising a bottom pad, an upper pad and a shock-absorbing layer is provided. The bottom pad has human foot-shaped profile and includes a plurality of stress zones. The upper pad is arranged opposite to the bottom pad and has human foot-shaped profile almost the same as that of the bottom pad. The shock-absorbing layer is arranged between the bottom pad and the upper pad and includes a variable-dimension helical spring. Each of the pressure-bearing units is arranged in the manner that two ends of a pressure-bearing unit abut against the bottom pad and the upper pad respectively. Each of the pressure-bearing units has mechanical properties for bearing pressures put on the stress zones by the foot and can be elastically deformed in the longitudinal direction.

According to the invention, in the shock-absorbing layer shoe midsole, a plurality of pressure-bearing units is arranged in a plurality of stress zones between the bottom pad and the upper pad. Each of the stress zones bears correspondingly to various pressures that put on the shoe midsole by the foot. Each of the pressure-bearing units is arranged correspondingly to each of the stress zones has the same or different mechanical properties.

Each of the pressure-bearing units can have the same or different mechanical properties such as force bearing capabilities, flexibility, stability and others. the pressure-bearing units arranged in the different stress zone have different mechanical properties form each other to bear various pressures put on various areas of different stress zones by the foot.

Specifically, each of the pressure-bearing units has mechanical properties such as higher force bearing capacity for bearing pressures or stress put by the foot, and good flexibility and higher deflection capacity that can be elastically deformed in the longitudinal direction. Further, all of the pressure-bearing units arranged in the same stress zone have same mechanical properties from each other;

In order to improve mechanical properties of shoe midsole, weight ratio of pressure-bearing unit having higher mechanical strength. Thereby, the shoe midsole of the present invention can provide an even shock-reducing effect correspondingly to various forces on different portions put by the foot, an increased comfort on the users, and avoid causing sports injury.

### BRIEF DESCRIPTION OF THE DRAWINGS

FIG. 1 is a diagram showing force distribution on the bottom of foot of a person when he is walking or running.

FIG. 2 is a plan view of a shoe midsole illustrated as an embodiment of the present invention.

FIG. 3 is a schematic perspective view of the shoe midsole of FIG. 2.

FIG. 4a, FIG. 4b and FIG. 4c separately depict various types of helical springs for the shoe midsole according to the present invention.

FIG. 5 is a schematic side view of the shoe midsole showing a profile of various dimensions at different zones before and after bearing compression.

### DETAILED DESCRIPTION OF THE PREFERRED EMBODIMENTS

In order to improve clearer understanding the technical features, objectives and effects of the present invention, some specific embodiments will now be described in detail with reference to illustrated drawings annexed herewith. The detailed description and technical contents of the present invention are described as follows in conjunction with the drawings. However, the drawings are only provided for reference and explanation, and are not used to limit the creation.

In addition, regarding the foregoing and other technical contents, features and effects of the present invention, it will be clearly presented in the detailed description of each embodiment with reference to the drawings. The directional terms mentioned in the following embodiments, for example: “up”, “down”, “left”, “right”, “front”, “rear”, etc., are just for reference to the directions shown in attached drawings.

Furthermore, in the following embodiments, the same or similar elements will be denoted by using the same or similar element numbers. In addition, the terms “first” and “second” mentioned in this specification or claims are only used to name the element or to distinguish different embodiments or ranges and are not used to express the Upper or lower limit in the number of elements.

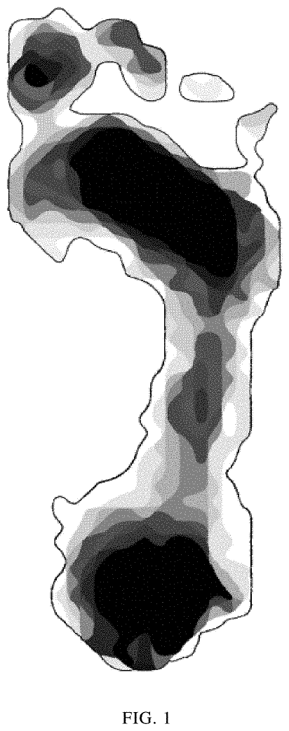

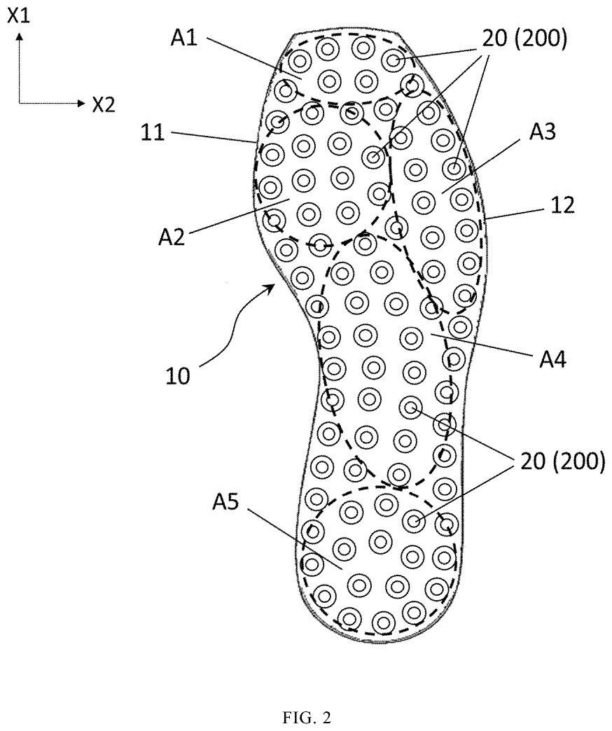

Please refer to FIGS. 2, 3 and 5 where embodiments of the shoe midsole of the present invention are illustrated. The shoe midsole 100 according to the present invention comprises a bottom pad 10, a shock-absorbing layer 20 and an upper pad 30. Based on forces distribution as shown in FIG. 1, it indicates that a force put on the bottom of foot will also exerts an opposite force on a shoe midsole. Accordingly, the shoe midsole 100 can be divided into a number of different force-receiving zones, and thus a springs substrate having different mechanical properties can be set on each of the force-receiving zones.

The distribution of forces received by sole will vary with the age and weight of the test subject. The force distribution shown in FIG. 1 is measured from a person who is 27 years old, 58 kg weight and 168 cm tall.

In this embodiment, the shoe midsole 100 is divided into five zones correspondingly to the force distribution shown in FIG. 1. Specifically, as shown in FIG. 2, the bottom pad 10 is divided into five areas as shown in FIG. 2, which are a thumb zone A1, a forefoot zone A2, a midfoot-1 zone A3, a midfoot-2 zone A4, and a rear foot zone A5. Preferably, each size of A1, A2, A3, A4 and A5 shows relationship satisfied with the following formula:

A4>A3>A2≥A5>A4

Further, the forces caused by the foot separately put on the plurality of stress zones A1, A2, A3, A4 and A5 show relationship satisfied with the following formula:

F2>F5>F1>F3>F4
in the formula,
F1 represents force caused by the foot put on the thumb zone A1;
F2 represents force caused by the foot put on the forefoot zone A2;
F3 represents force caused by the foot put on the midfoot-1 zone A3;
F4 represents force caused by the foot put on the midfoot-2 zone A4; and
F5 represents force caused by the foot put on the rear foot zone A5.

In one embodiment, for example, as shown on FIG. 1, a force F1 put on toe force area A1 is measured as 360 N, a force F2 put on forefoot force area A2 is measured as 620N, a force F3 put on first midfoot force area A3 is measured as 340N, a force F4 put on second midfoot force area A4 is measured as 300N, a force F5 put on rear foot force area A5 is measured as 450N.

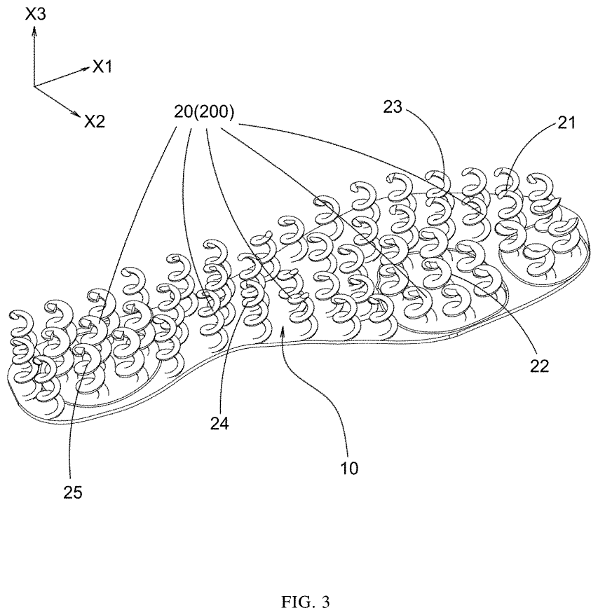

As shown in FIG. 3, the shock-absorbing layer 20 is arranged between the bottom pad 10 and the upper pad 30. In this embodiment, the shock-absorbing layer 20 includes pressure-bearing unit groups 21, 22, 23, 24, and 25, each of which is arranged correspondingly to stress zones such as A1, A2, A3, A4 and A5 on the bottom pad 10.

Each of pressure-bearing unit groups 21-25 is composed of a plurality of pressure-bearing units 200 respectively. Each of the pressure-bearing units has mechanical properties such as higher force bearing capacity for bearing pressures or stress put by the foot, and good flexibility and higher deflection capacity that can be elastically deformed in a longitudinal direction. In this embodiment, the pressure-bearing unit 200 is preferably a spiral spring-shaped element. The two ends of each pressure-bearing unit 200 are preferably configured to be respectively connected or abut to bottom pad 10 and upper pad 30. Further, each pressure-bearing unit 200 also preferably can be elastically deformed in the direction that is perpendicular to bottom pad 10 and upper pad 30 to generate excellent effects such as cushioning and shock-absorbing.

In addition, according to conception of the invention as described above, the number of pressure-bearing cells 200 provided in force-receiving areas may be arranged correspondingly to the force put on each of force-receiving areas such as A1 to A5 and/or based on each size of force-receiving areas.

Preferably, total number of pressure-bearing units disposed in the thumb zone A1, the forefoot zone A2, the midfoot-1 zone A3, the midfoot-2 zone A4 and the rear foot zone A5 shows relationship satisfied with the following formula:

N4>N3>N2>N5>N1
in the formula,
N1 represents total number of the pressure-bearing units disposed on the thumb zone A1;
N2 represents total number of the pressure-bearing units disposed on the forefoot zone A2;
N3 represents total number of the pressure-bearing units disposed on the midfoot-1 zone A3;
N4 represents total number of the pressure-bearing units disposed on the midfoot-2 zone A4; and
N5 represents total number of the pressure-bearing units disposed on the rear foot zone A5.

For example, in one illustrated embodiment of the shoe midsole according to the invention, N1 represents 4, N2 represents 8, N3 represents 12, N4 represents 22 and N5 represents 7. Each of pressure-bearing units arranged on toe force area A1 is configured to be able to bear a force at least 90N. Each of pressure-bearing units arranged on toe force area A2 is configured to be able to bear a force at least 77N.

Each of pressure-bearing units arranged on toe force area A3 is configured to be able to bear a force at least 28N. Each of pressure-bearing units arranged on toe force area A4 is configured to be able to bear a force at least 13.5N. Each of pressure-bearing units arranged on toe force area A5 is configured to be able to bear a force at least 64N.

The number of each of pressure-bearing units arranged on stress zones such as A1-A5, and total forces and individual forces received by each of pressure-bearing units are shown on Table 1 as below.

| Force | Number of pressure-bearing | Total Force | Individual Force |
|---|---|---|---|
| Area | units | (N) | (N) |
| A1 | 4 | 360 | 90 |
| A2 | 8 | 620 | 77 |
| A3 | 12 | 340 | 28 |
| A4 | 22 | 300 | 13.5 |
| A5 | 7 | 450 | 64 |

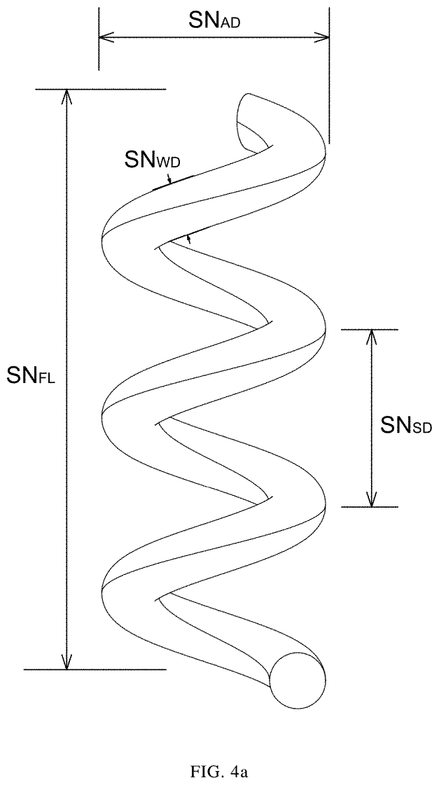

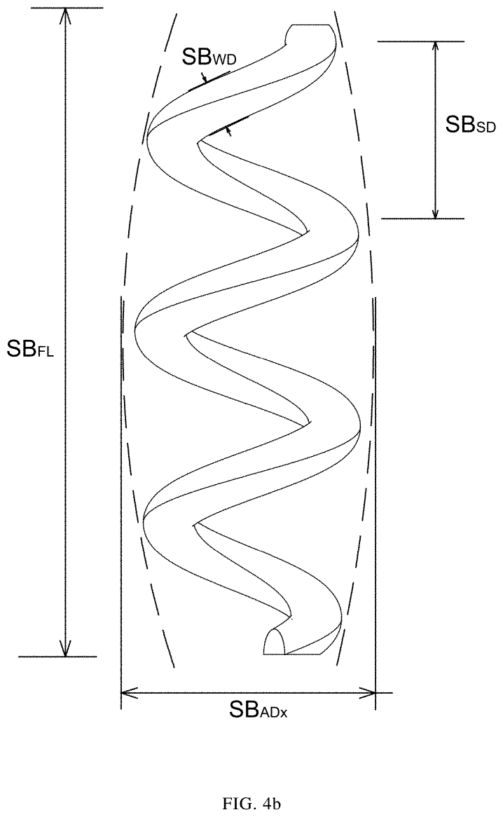

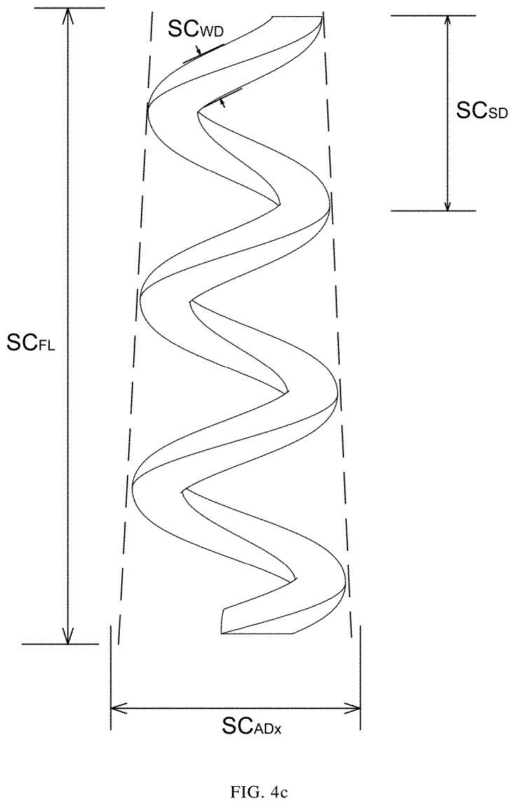

In order to improve mechanical properties of pressure-bearing unit groups 21-25 and to optimize its strength-to-weight ratio of shoe midsole, various midsoles comprising the same or different pressure-bearing unit 200 are preferably used in the invention. In one embodiment, pressure-bearing unit 200 is preferably a unit composed of at least one selected from normal spring type unit (SN unit) as shown on FIG. 4a, barrel spring type unit (SB unit) as shown on FIG. 4b and tapered spring type unit (SC unit) as shown on FIG. 4c, or the combination thereof.

According to the invention, all of pressure-bearing unit groups 21-25 arranged on stress zones such as A1-A5 could be the same type or a combination of different types. For example, all of pressure-bearing unit groups 21-25 may be formed by the same SN unit, SB unit, or SC unit, optionally formed by at least two or three types selected from the group consisting of SN unit, SB unit and SC unit.

In order to acquire desired mechanical properties, with respect to SN unit, SB unit and SC unit, it can be designed by various parameters approach for deigning of variable-dimension and uniform-dimension, for example, the trial and error method carried out with the validation of FEA method, Castiglioni's theorem approach, non-linear method has often preferred. The force acted on a spring can be calculated by the formula F=kΔx according to Hooke's law, namely, the elastic coefficient multiplied by the deformation of the spring. The mechanical properties of the spring are corresponding to the elastic coefficient of the spring.

According to the invention, various non-linear equations as follows are preferred.

$$\begin{matrix}k = \frac{{d}^{4} G}{8 {D}^{3} N} & Equation ( 1 ) \\ k = \frac{G {d}^{4}}{2 * n * D C} & Equation ( 2 ) \\ D C = ( {D}_{max}^{2} + {D}_{min}^{{2}_{i}} ) * ( {D}_{max} + {D}_{min} ) & Equation ( 3 )\end{matrix}$$

In these equations, D is the mean helical diameter (mm); G represents modulus of rigidity (MPa); N denotes the number of active turns; k is the stiffness of spring (N/mm); d is the wire diameter (mm) and DC is the combined value of the maximum and minimum helical diameter (mm).

Accordingly, the desired mechanical properties of pressure-bearing unit 200 could be obtained by optimal change of the average diameter of the helical spring, selection of appropriate material, adjustment of the number of effective turns, and others with respect to normal spring as shown on FIG. 4a, barrel spring as shown on FIG. 4b and tapered spring as shown on FIG. 4c.

In one embodiment of the invention, pressure-bearing unit 200 could be SN unit made by normal spring. Preferably, it is made by a normal spring, of which wire diameter of the normal spring SN_{WD} is in the range of 2.5 mm˜4.2 mm; pitch of barrel spring SN_{SD} is in the range of 8 mm˜14 mm; average outer diameter of the normal spring SN_{AD} is in the range of 14 mm˜18 mm; the number of effective turns of the normal spring S N_{EN} is in the range of 3˜8; and free length of the normal spring SN_{FL} is in the range of 16 mm˜36 mm. in addition, mass of the normal spring SNMA is in the range of 75 g˜85 g.

In another one embodiment of the invention, pressure-bearing unit 200 could be SB unit made by barrel spring. Preferably, it is made by a barrel spring, of which wire diameter of the barrel spring SB_{WD} is in the range of 2.7 mm˜4.8 mm; pitch of barrel spring SB_{SD} is in the range of 7 mm˜13 mm; minimum outer diameter of the barrel spring SB_{ADS} is in the range of 10 mm˜14 mm; maximum outer diameter of the barrel spring SB_{ADx} is in the range of 14 mm˜18 mm; the number of effective turns of the barrel spring SB_{EN} is in the range of 4˜10; and free length of the barrel spring SB_{FL} is in the range of 16 mm˜36 mm. in addition, mass of the barrel spring SBMA is in the range of 90 g˜100 g.

In the other one embodiment of the invention, pressure-bearing unit 200 could be SC unit made by tapered spring. Preferably, it is made by a tapered spring, of which wire diameter of the tapered spring SC_{WD} is in the range of 2.8 mm˜4.8 mm; pitch of tapered spring SC_{SD} is in the range of 6 mm˜13 mm; minimum outer diameter of the tapered spring SCA_{D}S is in the range of 6 mm˜10 mm; maximum outer diameter of the tapered spring SC_{ADx} is in the range of 14 mm˜18 mm; the number of effective turns of the tapered spring SC_{EN} is in the range of 4˜10; and free length of the tapered spring SC_{FL} is in the range of 16 mm˜36 mm. in addition, mass of the tapered spring SCMA is in the range of 85 g˜95 g.

According to those as mentioned above, each of pressure-bearing unit 200 to be arranged on stress zones such as A1-A5 could have different mechanical properties.

For example, in one illustrated example, each of pressure-bearing unit of the pressure-bearing unit groups 21-25 disposed in the thumb zone A1, the forefoot zone A2, the midfoot-1 zone A3, the midfoot-2 zone A4 and the rear foot zone A5 is the same SN unit that composed by same diameter wire in same helical pitch and same effective circle number.

Preferably, the pressure-bearing unit 200 is SN unit made with a normal helical spring. In such case, the wire diameter of each SN unit used as pressure-bearing unit 200 set in each of different zones of shoe midsole shows relationship satisfied with the following formula:

SN_{WD5}=SN_{WD2}=SN_{WD1}=SN_{WD3}=SB_{WD4}

Preferably, SN_{WD1} represents the wire diameter of the pressure-bearing unit set in thumb zone A1;

SN_{WD2} represents the wire diameter of each SN unit used as the pressure-bearing unit set in forefoot zone A2;

SN_{WD3} represents the wire diameter of each SN unit used as the pressure-bearing unit set in midfoot-1 zone A3;

SN_{WD4} represents the wire diameter of each SN unit used as the pressure-bearing unit set in midfoot-2 zone A4;

SN_{WD5} represents the wire diameter of each SN unit used as the pressure-bearing unit set in rear foot zone A5.

Preferably, the average diameter of each SN unit used as pressure-bearing unit 200 set in different zones of shoe midsole shows relationship satisfied with the following formula:

SN_{OD5}=SN_{OD2}=SN_{OD1}>SN_{OD3}=SN_{OD4}

In the formula, SN_{OD1} represents the average diameter of the pressure-bearing unit set in thumb zone A1;

SN_{OD2} represents the average diameter of each SN unit used as the pressure-bearing unit set in forefoot zone A2;

SN_{OD3} represents the average diameter of each SN unit used as the pressure-bearing unit set in midfoot-1 zone A3;

SN_{OD4} represents the average diameter of each SN unit used as the pressure-bearing unit set in midfoot-2 zone A4;

SN_{OD5} represents the average diameter of each SN unit used as the pressure-bearing unit set in rear foot zone A5.

Preferably, the pitch of each SN unit used as pressure-bearing unit 200 set in different zones of shoe midsole shows relationship satisfied with the following formula:

SN_{SD1}=SN_{SD2}=SN_{SD3}=SN_{SD4}⁼SN_{SD5}

In the formula, SN_{SD1} represents the pitch of the pressure-bearing unit set in thumb zone A1;

SN_{SD2} represents the pitch of each SN unit used as the pressure-bearing unit set in forefoot zone A2;

SN_{SD3} represents the pitch of each SN unit used as the pressure-bearing unit set in midfoot-1 zone A3;

SN_{SD4} represents the pitch of each SN unit used as the pressure-bearing unit set in midfoot-2 zone A4;

SN_{SD5} represents the pitch of each SN unit used as the pressure-bearing unit set in rear foot zone A5.

Preferably, the active helical turns of each SN unit used as pressure-bearing unit 200 set in different zones of shoe midsole shows relationship satisfied with the following formula:

SN_{EN1}⁼SN_{EN2}=SN_{EN3}=SN_{EN4}⁼SN_{EN5}

In the formula, SN_{EN1} represents the active helical turns of each SN unit used as the pressure-bearing unit set in thumb zone A1;

SN_{EN2} represents the active helical turns of each SN unit used as the pressure-bearing unit set in forefoot zone A2;

SN_{EN3} represents the active helical turns of each SN unit used as the pressure-bearing unit set in midfoot-1 zone A3;

SN_{EN4} represents the active helical turns of each SN unit used as the pressure-bearing unit set in midfoot-2 zone A4;

SN_{EN5} represents the active helical turns of each SN unit used as the pressure-bearing unit set in rear foot zone A5.

Furthermore, it is preferred that at least two types of SN unit with different mechanic properties or structural parameters, are disposed on stress zones such as A1 to A5 being used as the pressure-bearing unit of the invention.

For example, two types of SN unit are preferably used as the pressure-bearing unit to be disposed on stress zones such as A1 to A5, in which one type of SN unit with smaller tensile or higher stiffness to withstand the high force influence is separately used for stress zones such as A1, A2 and A5; and another on type of SN unit with higher tensile or smaller stiffness to withstand the less force influence is separately used for stress zones such as A3 and A4.

Further, the structural parameters such as wire diameter, average diameter, pitch and active helical turns of normal spring-shaped unit (SN unit) disposed in stress zones such as A1-A5, can be obtained by using the 3D modeling parametric software provided by PTC, 2011. 3D CAD Software|Creo [WWW Document]. URL https://www.ptc.com/en/products/cad/creo. The optimal structural parameters such as wire diameter, average diameter, pitch and active helical turns of SN unit are shown on Table 2 as an illustrated example but not limited to those.

Preferably, two types of normal spring-shaped unit (SN unit) 200 with structural parameters shown on Table 2 are separately used as the pressure-bearing unit to be disposed on stress zones such as A1 to A5, in which one type of normal spring-shaped unit (SN unit) is used for stress zones such as A1, A2 and A5; another one type of normal spring-shaped unit (SN unit) is used for stress zones such as A3 and A4.

TABLE 2
SN unit

| Force | wire diameter | average diameter | pitch | Active helical |
|---|---|---|---|---|
| area | (mm) | (mm) | (mm) | turns |
| A1 | 2.8 | 15 | 11 | 3 |
| A2 | 2.8 | 15 | 11 | 3 |
| A3 | 2.8 | 13 | 11 | 3 |
| A4 | 2.8 | 13 | 11 | 3 |
| A5 | 2.8 | 15 | 11 | 3 |

Preferably, as shown on Table 2, in each of force zones A1 to A5, the normal spring-shaped unit (SN unit) is designed with different average diameter to have required force bearing capacity with lower energy loss, increased the load-bearing and resilience capabilities.

For example, in another one illustrated example, each of pressure-bearing unit of the pressure-bearing unit groups 21-25 disposed in the thumb zone A1, the forefoot zone A2, the midfoot-1 zone A3, the midfoot-2 zone A4 and the rear foot zone A5 is the same SB unit (barrel-shaped unit) that composed by same diameter wire in same helical pitch and same effective helical turns.

Preferably, the pressure-bearing unit 200 is SB unit made with a barrel-shaped spring. In such case, the wire diameter of pressure-bearing unit 200 set in each of different zones of shoe midsole shows relationship satisfied with the following formula:

SB_{WD5}>SB_{WD2}>SB_{WD1}>SB_{WD3}>SB_{WD4}

In the formula, SB_{WD1} represents the wire diameter of each SB unit used as the pressure-bearing unit set in thumb zone A1;

SB_{WD2} represents the wire diameter of each SB unit used as the pressure-bearing unit set in forefoot zone A2;

SB_{WD3} represents the wire diameter of each SB unit used as the pressure-bearing unit set in midfoot-1 zone A3;

SB_{WD4} represents the wire diameter of each SB unit used as the pressure-bearing unit set in midfoot-2 zone A4;

SB_{WD5} represents the wire diameter of each SB unit used as the pressure-bearing unit set in rear foot zone A5.

Preferably, the average outer diameter of each SB unit used as pressure-bearing unit 200 set in each of different zones of shoe midsole shows relationship satisfied with the following formula:

SB_{OD5}=S_{OD2}=SB_{OD1}>SB_{OD3}=SB_{OD4}

In the formula, SB_{WD1} represents the average outer diameter of each SB unit used as the pressure-bearing unit set in thumb zone A1;

SB_{WD2} represents the average outer diameter of each SB unit used as the pressure-bearing unit set in forefoot zone A2;

SB_{WD3} represents the average outer diameter of each SB unit used as the pressure-bearing unit set in midfoot-1 zone A3;

SB_{WD4} represents the average outer diameter of each SB unit used as the pressure-bearing unit set in midfoot-2 zone A4;

SB_{WD5} represents the average outer diameter of each SB unit used as the pressure-bearing unit set in rear foot zone A5.

Preferably, the pitch of each SB unit used as pressure-bearing unit 200 set in each of different zones of shoe midsole shows relationship satisfied with the following formula:

SB_{SD1}=SB_{SD2}=SB_{SD3}=SB_{SD4}=SB_{SD5}

In the formula, SB_{WD1} represents the pitch of each SB unit used as the pressure-bearing unit set in thumb zone A1;

SB_{WD2} represents the pitch of each SB unit used as the pressure-bearing unit set in forefoot zone A2;

SB_{WD3} represents the pitch of each SB unit used as the pressure-bearing unit set in midfoot-1 zone A3;

SB_{WD4} represents the pitch of each SB unit used as the pressure-bearing unit set in midfoot-2 zone A4;

SB_{WD5} represents the pitch of each SB unit used as the pressure-bearing unit set in rear foot zone A5.

Preferably, number of the active turn of each SB unit used as pressure-bearing unit 200 set in each of different zones of shoe midsole shows relationship satisfied with the following formula:

SB_{EN1}=SB_{EN2}=SB_{EN3}=SB_{EN4}=SB_{EN5}

In the formula, SB_{WD1} represents number of the active turn of each SB unit used as the pressure-bearing unit set in thumb zone A1;

SB_{WD2} represents number of the active turn of each SB unit used as the pressure-bearing unit set in forefoot zone A2;

SB_{WD3} represents number of the active turn of each SB unit used as the pressure-bearing unit set in midfoot-1 zone A3;

SB_{WD4} represents number of the active turn of each SB unit used as the pressure-bearing unit set in midfoot-2 zone A4;

SB_{WD5} represents number of the active turn of each SB unit used as the pressure-bearing unit set in rear foot zone A5.

Furthermore, it is preferred that at least two types of barrel spring-shaped unit (SB unit) with different mechanical properties or structural parameters, are disposed on stress zones such as A1 to A5 being used as the pressure-bearing unit of the invention.

For example, two types of SB unit are preferably used as the pressure-bearing unit to be disposed on stress zones such as A1 to A5, in which one type of SB with smaller tensile or higher stiffness to withstand the high force influence is separately used for stress zones such as A1, A2 and A5; and another on type of SB unit with higher tensile or smaller stiffness to withstand the less force influence is separately used for stress zones such as A3 and A4.

Further, the structural parameters such as wire diameter, average diameter, pitch and active helical number of SB unit disposed in stress zones such as A1-A5, can be obtained by using the 3D modeling parametric software provided by PTC, 2011. 3D CAD Software|Creo [WWW Document]. URL https://www.ptc.com/en/products/cad/creo. The optimal structural parameters such as wire diameter, average diameter, pitch and active helical number of SB unit are shown on Table 2 as an illustrated example but not limited to those.

Preferably, two types of SB unit 200 with structural parameters shown on Table 3 are separately used as the pressure-bearing unit to be disposed on stress zones such as A1 to A5, in which one type of SB unit is used for stress zones such as A1, A2 and A5; another one type of SB unit is used for stress zones such as A3 and A4.

TABLE 3
SB unit

| Force | wire diameter | average diameter | pitch | Active helical |
|---|---|---|---|---|
| area | (mm) | (mm) | (mm) | turns |
| A1 | 4.25 | 15 | 11 | 3 |
| A2 | 4.3 | 15 | 11 | 3 |
| A3 | 3 | 13 | 11 | 3 |
| A4 | 2.9 | 13 | 11 | 3 |
| A5 | 4.6 | 15 | 11 | 3 |

Preferably, as shown on Table 2, in each of force zones A1 to A5, the SB unit is designed with different wire diameter to have desired force bearing capacity with lower energy loss, increased the load-bearing and resilience capabilities.

For example, in the other one illustrated example, each of pressure-bearing unit of the pressure-bearing groups 21-25 disposed in the thumb zone A1, the forefoot zone A2, the midfoot-1 zone A3, the midfoot-2 zone A4 and the rear foot zone A5 is the same SC unit (taper-shaped unit) that is composed by same wire diameter, same helical pitch and same effective helical turns.

Preferably, the pressure-bearing unit 200 is SC unit made with a taper-shaped spring. In such case, the wire diameter of pressure-bearing unit 200 set in each of different zones of shoe midsole shows relationship satisfied with the following formula:

SC_{WD5}>SC_{WD2}>SC_{WD1}>SC_{WD3}>SC_{WD4}

In the formula, SC_{WD1} represents the wire diameter of each SB unit used as the pressure-bearing unit set in thumb zone A1;

SC_{WD2} represents the wire diameter of each SC unit used as the pressure-bearing unit set in forefoot zone A2;

SC_{WD3} represents the wire diameter of each SC unit used as the pressure-bearing unit set in midfoot-1 zone A3;

SC_{WD4} represents the wire diameter of each SC unit used as the pressure-bearing unit set in midfoot-2 zone A4;

SC_{WD5} represents the wire diameter of each SC unit used as the pressure-bearing unit set in rear foot zone A5.

Preferably, the average outer diameter of each SC unit used as pressure-bearing unit 200 set in each of different zones of shoe midsole shows relationship satisfied with the following formula:

SC_{OD5}=SC_{OD2}=SC_{OD1}>SC_{OD3}=SC_{OD4}

In the formula, SB_{WD1} represents the average outer diameter of each SC unit used as the pressure-bearing unit set in thumb zone A1;

SC_{WD2} represents the average outer diameter of each SC unit used as the pressure-bearing unit set in forefoot zone A2;

SC_{WD3} represents the average outer diameter of each SC unit used as the pressure-bearing unit set in midfoot-1 zone A3;

SC_{WD4} represents the average outer diameter of each SC unit used as the pressure-bearing unit set in midfoot-2 zone A4;

SC_{WD5} represents the average outer diameter of each SC unit used as the pressure-bearing unit set in rear foot zone A5.

Preferably, the pitch of each SC unit used as pressure-bearing unit 200 set in each of different zones of shoe midsole shows relationship satisfied with the following formula:

SC_{SD1}=SC_{SD2}=SC_{SD3}=SC_{SD4}=SC_{SD5}

In the formula, SC_{WD1} represents the pitch of each SC unit used as the pressure-bearing unit set in thumb zone A1;

SC_{WD2} represents the pitch of each SC unit used as the pressure-bearing unit set in forefoot zone A2;

SC_{WD3} represents the pitch of each SC unit used as the pressure-bearing unit set in midfoot-1 zone A3;

SC_{WD4} represents the pitch of each SC unit used as the pressure-bearing unit set in midfoot-2 zone A4;

SC_{WD5} represents the pitch of each SC unit used as the pressure-bearing unit set in rear foot zone A5.

Preferably, number of the active turn of each SB unit used as pressure-bearing unit 200 set in each of different zones of shoe midsole shows relationship satisfied with the following formula:

SC_{EN1}=SC_{EN2}=SC_{EN3}=SC_{EN4}=SC_{EN5}

In the formula, SB_{WD1} represents number of the active turn of each SC unit used as the pressure-bearing unit set in thumb zone A1;

SC_{WD2} represents number of the active turn of each SC unit used as the pressure-bearing unit set in forefoot zone A2;

SC_{WD3} represents number of the active turn of each SC unit used as the pressure-bearing unit set in midfoot-1 zone A3;

SC_{WD4} represents number of the active turn of each SC unit used as the pressure-bearing unit set in midfoot-2 zone A4;

SC_{WD5} represents number of the active turn of each SC unit used as the pressure-bearing unit set in rear foot zone A5.

Furthermore, it is preferred that at least two types of tapered spring-shaped unit (SC unit) with different mechanical properties or structural parameters, are disposed on stress zones such as A1 to A5 being used as the pressure-bearing unit of the invention.

For example, two types of SB unit are preferably used as the pressure-bearing unit to be disposed on stress zones such as A1 to A5, in which one type of SC unit with smaller tensile or higher stiffness to withstand the high force influence is separately used for stress zones such as A1, A2 and A5; and another on type of SC unit with higher tensile or smaller stiffness to withstand the less force influence is separately used for stress zones such as A3 and A4.

Further, the structural parameters such as wire diameter, average diameter, pitch and active helical number of SB unit disposed in stress zones such as A1-A5, can be obtained by using the 3D modeling parametric software provided by PTC, 2011. 3D CAD Software|Creo [WWW Document]. URL https://www.ptc.com/en/products/cad/creo. The optimal structural parameters such as wire diameter, average diameter, pitch and active helical number of SC unit are shown on Table 4 as an illustrated example but not limited to those.

Preferably, two types of SC unit 200 with structural parameters shown on Table 3 are separately used as the pressure-bearing unit to be disposed on stress zones such as A1 to A5, in which one type of SB unit is used for stress zones such as A1, A2 and A5; another one type of SC unit is used for stress zones such as A3 and A4.

TABLE 4
SC unit

| Force | wire diameter | average diameter | pitch | Active helical |
|---|---|---|---|---|
| area | (mm) | (mm) | (mm) | turns |
| A1 | 4.25 | 15 | 11 | 3 |
| A2 | 4.3 | 15 | 11 | 3 |
| A3 | 3 | 13 | 11 | 3 |
| A4 | 2.9 | 13 | 11 | 3 |
| A5 | 4.6 | 15 | 11 | 3 |

Preferably, as shown on Table 4, in each of force zones A1 to A5, the SC unit is designed with different wire diameter to have desired force bearing capacity with lower energy loss, increased the load-bearing and resilience capabilities.

Preferably, the shoe midsole comprising bottom pad 10, shock-absorbing layer 20 and upper pad 30 is made by additive manufacturing process.

In addition, for insulation, vibration, and shock energy damping, etc., using light material or ultralight material is recommended to use in the midsole as a filler to solely support the spring structure from buckling and distortion. The filler is filled in the shock-absorbing layer 20 to cover the pressure-bearing units 21-25. The light-weight material is preferably used between the springs inside or among SN units, SB units or SC units to mitigate the instability of the elastic structure, and hence inhalation and exhalation of air will take place during the compression and expansion of the shoe midsole via holes therein.

Preferably, the light material is a porous material, for example, sponge, a sponge-like material. The ultralight material preferably has a density less than 10 mg/cm³, for example, graphene aerogel (ρ0.16 mg/cm³), silica aerogels (density ρ≥1 mg/cm³), metallic foams (ρ≥10 mg/cm³), shape memory polymer foam (ρ≥18 mg/cm³), and polyurethane foam (PUF) (ρ≥40 mg/cm³).

In addition, to investigate the mechanical properties of the load-deflection curves of various springs with the same height, volume fraction, and mass, but variable shapes, some experiments including uniaxial compression and loading-unloading tests and finite element analysis (FEA) were performed to investigate the load-bearing capacity, deflection, energy absorption, and energy loss when the applied load was removed from each spring.

According to the results of experiments, it shows the load-deflection curves of various springs with the same height, volume fraction, and mass, but variable shapes. This indicates that the load-bearing capacity of the helical springs is significantly influenced by the shape and mass distribution of each sample. Especially, a helical spring with a tapered shape in contrast with the uniform diameter of spring, has the maximum load-bearing capacity.

Preferably, various variable-dimension helical springs as shown on the table 5 below are suitable being used in the invention

As shown in Table 5, Spring 6 has the largest wire diameter and smallest value of pitch at one end, and the mean diameter is also comparatively smaller; therefore, the mass is distributed to increase the wire diameter. It is established that the wire diameter has the largest influence on the energy-absorption property of a helical spring; thus, a maximum load-bearing value for Spring 6 and it can also be proven using analytical calculations. Spring 5 has 43.85% less loading capacity than Spring 6. It has a small mean diameter at both ends; consequently, the mass saved by reducing mean diameter is used to strengthen the wire diameter, increasing the overall load-bearing capacity of the helical springs.

Accordingly, a shoe midsole according to the invention can be designed using at least two different types of variable dimension helical springs. The values of design parameter for each region of midsole is varied according to the foot pressure distribution.

Preferably, for each variable dimension helical spring, five different helical springs were designed and inserted to the solid midsole in order to convert it to spring structured midsole which is much lighter in weight, have excellent energy absorption (cushioning) and energy return.

Specifically, a midsole can be made as customized design variable dimension helical springs to be disposed according to foot pressure distribution, in different areas such as the thumb zone A1, the forefoot zone A2, the midfoot-1 zone A3, the midfoot-2 zone A4 and the rear foot zone A5.

For example, in case that the pressure-bearing unit 200 can be SB unit or SC unit, the number of springs disposed in each of the thumb zone A1, the forefoot zone A2, the midfoot-1 zone A3, the midfoot-2 zone A4 and the rear foot zone A5 is preferably more than 2 but less than 30. An illustrated example is shown on table 6.

TABLE 6
Zone wise distribution of force

| | | Number | Total | For per |
|---|---|---|---|---|
| | | of spring | force | spring |
| Zones | | (N) | (N) | (N) |
| A1: Thumb(Toe-off) | | 4 | 360 | 90 |
| A2: Forefoot (Impact Peak) | | 8 | 620 | 77 |
| End of | A3: Midfoot 1 | 12 | 340 | 28 |
| Midstance | A4: Midfoot 2 | 22 | 300 | 13.5 |

| | | | |
|---|---|---|---|
| A5: Heel(Touchdown) | 7 | 450 | 64 |

As shown in table 6, in the thumb zone A1, the number of springs can be in the ranges of 2 to 10. In the forefoot zone A2, the number of springs can be in the ranges of 5 to 15. In the midfoot-1 zone A3, the number of springs can be in the ranges of 5 to 20. In the midfoot-2 zone A4, the number of springs can be in the ranges of 10 to 50. In the rear foot zone A5, the number of springs can be in the ranges of 2 to 15.

In addition, each spring height has designed according to the fluctuated height of the midsole to bear the desired force as mentioned in table 6. Preferably, each spring has designed to bear the desired force as mentioned in table 6.

For example, as shown in table 6, in the thumb zone A1, each of springs is preferably designed to able to bear the force (N) in the ranges of 50 N to 150 N. In the forefoot zone A2, each of springs is preferably designed to able to bear the force (N) in the ranges of 35 N to 120 N. In the midfoot-1 zone A3, each of springs is preferably designed to able to bear the force (N) in the ranges of 10 N to 50 N. In the midfoot-2 zone A4, each of springs is preferably designed to able to bear the force (N) in the ranges of 50 N to 40 N. In the rear foot zone A5, each of springs is preferably designed to able to bear the force (N) in the ranges of 20 N to 100 N.

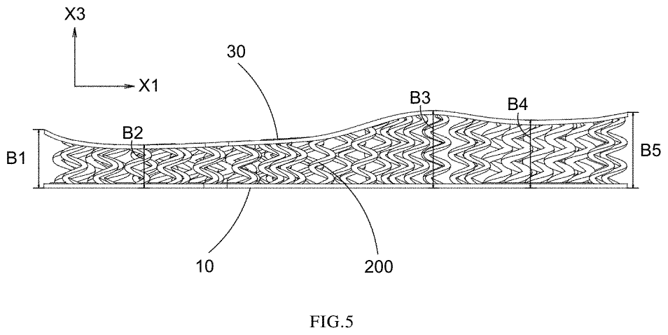

Further, refers to FIG. 5, it is a schematic side view of the shoe midsole showing a profile of various dimensions at different zones before and after bearing compression during a compression test on various conditions. For example, the difference ratio of various dimensions at different zones before and after bearing compression calculated according to results of a compression test under unloading or loading 300 N was shown in table 7.

TABLE 7

| | | Height | | Difference |
|---|---|---|---|---|
| Midsole | Location | without | Height under | Ratio (%) in |
| Type | (Zone) | loading (mm) | loading (mm) | Height |
| SN unit | B1 (A1) | 27 | 27 | 0.00 |
| | B2 (A2) | 22 | 20 | 9.09 |
| | B3 (A3) | 35 | 33 | 5.71 |
| | B4 (A4) | 31.5 | 26.5 | 15.87 |
| | B5 (A5) | 34.5 | 26.5 | 15.07 |
| SB unit | B1 (A1) | 27 | 25 | 7.41 |
| | B2 (A2) | 22 | 20 | 9.09 |
| | B3 (A3) | 35 | 34.9 | 0.29 |
| | B4 (A4) | 31.5 | 29.5 | 6.35 |
| | B5 (A5) | 34.5 | 34.2 | 0.87 |
| SC unit | B1 (A1) | 27 | 25.5 | 5.56 |
| | B2 (A2) | 22 | 20.5 | 6.82 |
| | B3 (A3) | 35 | 31.8 | 9.14 |
| | B4 (A4) | 31.5 | 30.5 | 3.17 |
| | B5 (A5) | 34.5 | 34.2 | 0.87 |

According to Table 7, it is found the size difference in height of midsole composed of a normal helical spring unit (SN unit) is in the range of 0.00˜15.87%, whereas for midsole composed of a barrel spring unit (SB unit) is in the range of 0.29˜9.09%, and for midsole composed of a tapered spring unit (SC unit) is in the range of 0.87˜9.14%. As shown in FIG. 5, free length of each pressure-bearing unit disposed in the thumb zone A1, the forefoot zone A2, the midfoot-1 zone A3, the midfoot-2 zone A4 and the rear foot zone A5 shows relationship satisfied with the following formula:

FL4>FL5>FL1>FL2=FL3,
wherein
FL1 represents free length of each pressure-bearing unit disposed on the thumb zone A1;
FL2 represents free length of each pressure-bearing unit disposed on the forefoot zone A2;
FL3 represents free length of each pressure-bearing unit disposed on the midfoot-1 zone A3;
FL4 represents free length of each pressure-bearing unit disposed on the midfoot-2 zone A4; and
FL5 represents free length of each pressure-bearing unit disposed on the rear foot zone A5.

Further, it is revealed that midsole composed of SN unit has most large deflection in height as compared to midsole composed of SB unit and/or midsole composed of SC unit. In addition, it is also revealed that the deflection in height of a midsole composed of SB unit is larger than that of a midsole composed of SC unit.

Overall, higher defection (difference ratio) in height is found in midsole composed of SN unit (45%) as compared to midsole composed of SB unit (24%) and midsole composed of SC unit (25%).

Summing up foregoing, according to the invention, the shoe midsole is half in weight than solid one but have improved properties such as high energy absorption, high energy return, acceptable stiffness, high compression distance, and so on.

However, the above are only the preferred embodiments of the present invention and should not be used to limit the scope of implementation of the present invention, that is, the simple equivalents made according to the scope of patent application and description of the invention Changes and modifications are still within the scope of the patent for this invention.

What is claimed is:

1. A shoe midsole having a structure formed by additive manufacturing process, which is characterized in comprising:
a bottom pad having foot-shaped profile, which includes a plurality of stress zones, each of the stress zones bears a part of pressure put by a foot;
an upper pad arranged opposite to the bottom pad, which has foot-shaped profile almost identical to that of the bottom pad; and
a shock-absorbing layer arranged between the bottom pad and the upper pad, which includes a plurality of pressure-bearing units arranged on a location corresponding to each of the stress zones in a manner that two ends of each pressure-bearing unit abuts against the bottom pad and the upper pad respectively;
wherein each of the pressure-bearing units has mechanical properties such as higher force bearing capacity for bearing pressures or stress put by the foot, and good flexibility and higher deflection capacity that can be elastically deformed in a longitudinal direction;
wherein all of the pressure-bearing units arranged in the same stress zone have the same mechanical properties from each other;
wherein the pressure-bearing units arranged in the different stress zones have different mechanical properties form each other to bear various pressures put on various areas of different stress zones by the foot.

2. The shoe midsole according to claim 1, in which the plurality of stress zones comprises:
a thumb zone A1, which is corresponding to a region near toe of the foot;
a forefoot zone A2, which is corresponding to a region near medial side beneath toe of the foot;
a midfoot-1 zone A3, which is corresponding to a midfoot region near lateral side beneath toe of the foot;
a midfoot-2 zone A4, which is corresponding to an area near a longitudinal arch region of the foot; and
a rear foot zone A5, which is corresponding to an area near calcaneus region of the foot;
wherein the forces caused by the foot separately put on the plurality of stress zones show relationship satisfied with a following formula:
F2>F5>F1>F3>F4,
wherein
F1 represents force caused by the foot put on the thumb zone A1;
F2 represents force caused by the foot put on the forefoot zone A2;
F3 represents force caused by the foot put on the midfoot-1 zone A3;
F4 represents force caused by the foot put on the midfoot-2 zone A4; and
F5 represents force caused by the foot put on the rear foot zone A5.

3. The shoe midsole according to claim 2, wherein each of pressure-bearing unit is configured to be one selected from a group consisting of a normal helical spring unit (SN unit), a barrel spring unit (SB unit), a tapered spring unit (SC unit), and combination thereof.

4. The shoe midsole according to claim 3, wherein SN unit has physical properties as follows:
a wire diameter SN_{WD} in a range of 2.5 mm˜4.2 mm;
a spring pitch SN_{SD} in a range of 8 mm˜14 mm;
an average diameter SN_{AD} in a range of 14 mm˜18 mm;
an effective circle number SN_{EN} in a range of 3˜8;
a free length SN_{FL} in a range of 16 mm˜36 mm; and
a mass SN_{MA} in a range of 75 g˜85 g.

5. The shoe midsole according to claim 2, wherein SB unit has physical properties as follows:
a wire diameter SB_{WD} in a range of 2.7 mm˜4.8 mm;
a spring pitch SB_{SD} in a range of 7 mm˜13 mm;
a minimum average diameter SB_{ADS} in a range of 10 mm˜14 mm;
a maximum average diameter SB_{ADx} in a range of 14 mm˜18 mm;
an effective circle number SB_{EN} in a range of 4˜10;
a free length SB_{FL} in a range of 16 mm˜36 mm; and
a mass SB_{MA} in a range of 90 g˜100 g.

6. The shoe midsole according to claim 2, wherein SC unit has physical properties as follows:
a wire diameter SC_{WD} in a range of 2.8 mm˜4.8 mm;
a spring pitch SC_{SD} in a range of 6 mm˜13 mm;
a minimum average diameter SC_{ADS} in a range of 6 mm˜10 mm;
a maximum average diameter SC_{ADx} in a range of 14 mm˜18 mm;
an effective circle turns SC_{EN} in a range of 4˜10;
a free length SC_{FL} in a range of 16 mm˜36 mm; and
a mass SC_{MA} in a range of 85 g˜95 g.

7. The shoe midsole according to claim 3, wherein each of pressure-bearing unit disposed in the thumb zone A1, the forefoot zone A2, the midfoot-1 zone A3, the midfoot-2 zone A4 and the rear foot zone A5 is the SN unit that composed by identical diameter wire in identical helical pitch and identical effective circle turns, and an average diameter of the SN units show relationship satisfied with the following formula:
SN_{OD5}=SN_{OD2}=SN_{OD1}>SN_{OD3}=SN_{OD4},
wherein
SN_{OD1} represents the average diameter of the SN units disposed on the thumb zone A1;
SN_{OD2} represents the average diameter of the SN units disposed on the forefoot zone A2;
SN_{OD3} represents the average diameter of the SN units disposed on the midfoot-1 zone A3;
SN_{OD4} represents the average diameter of the SN units disposed on the midfoot-2 zone A4; and
SN_{OD5} represents the average diameter of the SN units disposed on the rear foot zone A5.

8. The shoe midsole according to claim 3, wherein each of pressure-bearing unit disposed in the thumb zone A1, the forefoot zone A2, the midfoot-1 zone A3, the midfoot-2 zone A4 and the rear foot zone A5 is the SB unit having identical helical pitch and identical effective circle number, that composed by different diameter wire show relationship satisfied with the following formula:
SB_{WD5}>SB_{WD2}>SB_{WD1}>SB_{WD3}>SB_{WD4},
wherein
SB_{WD1} represents diameter of wire of the SB unit disposed on the thumb zone A1;
SB_{WD2} represents diameter of wire of the SB unit disposed on the forefoot zone A2;
SB_{WD3} represents diameter of wire of the SB unit disposed on the midfoot-1 zone A3;
SB_{WD4} represents diameter of wire of the SB unit disposed on the midfoot-2 zone A4; and
SB_{OD5} represents diameter of wire of the SB unit disposed on the rear foot zone A5;
wherein an average diameter of the SN units show relationship satisfied with the following formula:
SB_{OD5}=SB_{OD2}=SB_{OD1}>SB_{OD3}=SB_{OD4}
wherein
SB_{OD1} represents the average diameter of the SN units disposed on the thumb zone A1;
SB_{OD2} represents the average diameter of the SN units disposed on the forefoot zone A2;
SB_{OD3} represents the average diameter of the SN units disposed on the midfoot-1 zone A3;
SB_{OD4} represents the average diameter of the SN units disposed on the midfoot-2 zone A4; and
SB_{OD5} represents the average diameter of the SN units disposed on the rear foot zone A5.

9. The shoe midsole according to claim 3, wherein each of pressure-bearing unit disposed in the thumb zone A1, the forefoot zone A2, the midfoot-1 zone A3, the midfoot-2 zone A4 and the rear foot zone A5 is the SC unit having same helical pitch and same effective circle number, that composed by different diameter wire show relationship satisfied with the following formula:
SC_{WD5}>SC_{WD2}>SC_{WD1}>SC_{WD3}>SC_{WD4}
wherein
SC_{WD1} represents diameter of wire of the SC unit disposed on the thumb zone A1;
SC_{WD2} represents diameter of wire of the SC unit disposed on the forefoot zone A2;
SC_{WD3} represents diameter of wire of the SC unit disposed on the midfoot-1 zone A3;
SC_{WD4} represents diameter of wire of the SC unit disposed on the midfoot-2 zone A4; and
SC_{OD5} represents diameter of wire of the SC unit disposed on the rear foot zone A5;
wherein an average diameter of the SN units show relationship satisfied with the following formula:
SC_{OD5}=SC_{OD2}=SC_{OD1}>SC_{OD3}=SC_{OD4}
wherein
SC_{OD1} represents the average diameter of the SN units disposed on the thumb zone A1;
SC_{OD2} represents the average diameter of the SN units disposed on the forefoot zone A2;
SC_{OD3} represents the average diameter of the SN units disposed on the midfoot-1 zone A3;
SC_{oD4} represents the average diameter of the SN units disposed on the midfoot-2 zone A4; and
SC_{OD5} represents the average diameter of the SN units disposed on the rear foot zone A5.

10. The shoe midsole according to claim 9, wherein total number of pressure-bearing units disposed in the thumb zone A1, the forefoot zone A2, the midfoot-1 zone A3, the midfoot-2 zone A4 and the rear foot zone A5 shows relationship satisfied with the following formula:
N4>N3>N2>N5>N1,
wherein
N1 represents total number of the pressure-bearing units disposed on the thumb zone A1;
N2 represents total number of the pressure-bearing units disposed on the forefoot zone A2;
N3 represents total number of the pressure-bearing units disposed on the midfoot-1 zone A3;
N4 represents total number of the pressure-bearing units disposed on the midfoot-2 zone A4; and
N5 represents total number of the pressure-bearing units disposed on the rear foot zone A5.

11. The shoe midsole according to claim 9, wherein free length of each pressure-bearing unit disposed in the thumb zone A1, the forefoot zone A2, the midfoot-1 zone A3, the midfoot-2 zone A4 and the rear foot zone A5 shows relationship satisfied with the following formula:
FL4>FL5>FL1>FL2=FL3,
wherein
FL1 represents free length of each pressure-bearing unit disposed on the thumb zone A1;
FL2 represents free length of each pressure-bearing unit disposed on the forefoot zone A2;
FL3 represents free length of each pressure-bearing unit disposed on the midfoot-1 zone A3;
FL4 represents free length of each pressure-bearing unit disposed on the midfoot-2 zone A4; and
FL5 represents free length of each pressure-bearing unit disposed on the rear foot zone A5.

12. The shoe midsole according to claim 8, wherein total number of pressure-bearing units disposed in the thumb zone A1, the forefoot zone A2, the midfoot-1 zone A3, the midfoot-2 zone A4 and the rear foot zone A5 shows relationship satisfied with the following formula:
N4>N3>N2>N5>N1,
wherein
N1 represents total number of the pressure-bearing units disposed on the thumb zone A1;
N2 represents total number of the pressure-bearing units disposed on the forefoot zone A2;
N3 represents total number of the pressure-bearing units disposed on the midfoot-1 zone A3;
N4 represents total number of the pressure-bearing units disposed on the midfoot-2 zone A4; and
N5 represents total number of the pressure-bearing units disposed on the rear foot zone A5.

13. The shoe midsole according to claim 8, wherein free length of each pressure-bearing unit disposed in the thumb zone A1, the forefoot zone A2, the midfoot-1 zone A3, the midfoot-2 zone A4 and the rear foot zone A5 shows relationship satisfied with the following formula:
FL4>FL5>FL1>FL2=FL3,
wherein
FL1 represents free length of each pressure-bearing unit disposed on the thumb zone A1;
FL2 represents free length of each pressure-bearing unit disposed on the forefoot zone A2;
FL3 represents free length of each pressure-bearing unit disposed on the midfoot-1 zone A3;
FL4 represents free length of each pressure-bearing unit disposed on the midfoot-2 zone A4; and
FL5 represents free length of each pressure-bearing unit disposed on the rear foot zone A5.

14. The shoe midsole according to claim 7, wherein total number of pressure-bearing units disposed in the thumb zone A1, the forefoot zone A2, the midfoot-1 zone A3, the midfoot-2 zone A4 and the rear foot zone A5 shows relationship satisfied with the following formula:
N4>N3>N2>N5>N1,
wherein
N1 represents total number of the pressure-bearing units disposed on the thumb zone A1;
N2 represents total number of the pressure-bearing units disposed on the forefoot zone A2;
N3 represents total number of the pressure-bearing units disposed on the midfoot-1 zone A3;
N4 represents total number of the pressure-bearing units disposed on the midfoot-2 zone A4; and
N5 represents total number of the pressure-bearing units disposed on the rear foot zone A5.

15. The shoe midsole according to claim 8, wherein free length of each pressure-bearing unit disposed in the thumb zone A1, the forefoot zone A2, the midfoot-1 zone A3, the midfoot-2 zone A4 and the rear foot zone A5 shows relationship satisfied with the following formula:
FL4>FL5>FL1>FL2=FL3,
wherein
FL1 represents free length of each pressure-bearing unit disposed on the thumb zone A1;
FL2 represents free length of each pressure-bearing unit disposed on the forefoot zone A2;
FL3 represents free length of each pressure-bearing unit disposed on the midfoot-1 zone A3;
FL4 represents free length of each pressure-bearing unit disposed on the midfoot-2 zone A4; and
FL5 represents free length of each pressure-bearing unit disposed on the rear foot zone A5.

16. The shoe midsole according to claim 1, which further comprises a filler that is filled in the shock-absorbing layer to cover the pressure-bearing unit, wherein the filler is a porous material.
